(19) United States
(12) Patent Application Publication
(10) Pub. No.: US 2003/0008051 A1
(43) Pub. Date: Jan. 9, 2003

(54) Method and composition for replacing part of whole liquid eggs in a bakery product with a composition comprising egg white in powder form or the like

(75) Inventor: Patrick Cavroy, Paris (FR)

Correspondence Address: YOUNG & THOMPSON, 745 SOUTH 23RD STREET 2ND FLOOR, ARLINGTON, VA, 22202

(73) Assignee: FOCO, PARIS (FR)

(21) Appl. No.: 10/218,496

(22) Filed: Aug. 15, 2002

Related U.S. Application Data
(63) Continuation of application No. 09/807,626, filed on Apr. 16, 2001.
Application No. 09/807,626 is a 371 of international application No. PCT/FR99/02453, filed on Oct. 12, 1999.

(30) Foreign Application Priority Data
Oct. 14, 1998 (FR) 98/12872
Dec. 4, 1998 (EP) 98403050.2

(51) Int. Cl. A21D 13/08

(52) U.S. Cl. 426/556

(57) ABSTRACT

A method for preparing a pastry-Vienna bakery product requiring whole eggs, wherein part of the eggs required for obtaining a specific quality for the pastry-Vienna bakery product are replaced by the addition of a preparation based on a solid composition containing egg white in powder form or one of the equivalent products well-known in the agri-food field. The invention also concerns powder compositions and their use for using fewer whole eggs (yolk and white) required for preparing a pastry-Vienna bakery product.

The present invention relates to a method for preparing pastry—Viennese bakery and similar products which allows the quantity of eggs used to be reduced and/or the appearance of these products to be improved, as well as preparations conceived for this purpose.

As soon as the production of pastry—Viennese bakery products started to become industrialised, companies involved in this sector sought to economise. The most useful economies appear to have been made in relation to the quantity of eggs used.

Egg white substitutes, which thus replace egg white, have existed for a long time. However, these products are expensive, hold little interest and only bring about a small reduction in price. Whole egg substitutes also exist, which are thus destined to replace whole eggs. Finally, there are egg yolk substitutes.

Whole eggs used in the preparation of pastry—Viennese bakery products have many functions. Indeed, the egg rises during beating and during baking in the oven. The rising during beating is attributed to the viscosity of the egg, whereas the rising in the oven is attributed to the coagulation of the egg proteins.

That is why, in order to fulfil the first function, biscuit manufacturers immediately thought of using thickeners and therefore added vegetable gums to their base preparation, whereas they thought of adding proteins in order to achieve a good level of coagulation.

Therefore, in the sixties, preparations intended to reduce the amount of eggs used which were based on proteins (essentially skimmed milk) and vegetable gums (essentially gum of guar or carob and alginates) were marketed.

At the present, only proteins such as soya protein or de-starched rice, as well as gums such as xanthane, guar and carob gum are used.

However, these compounds do not allow more than a 7% reduction in the quantity of eggs used without deterioration in the quality of the product.

A method and products were still sought therefore, which would enable a relatively large amount of the eggs used in the preparation of pastry—Viennese bakery products to be reduced whilst maintaining the gustative qualities of the final product as well as good development of this product.

A method and products to improve the appearance of the final product were also sought.

U.S. Pat. No. 3,864,500 describes an egg yolk substitute which is useful for replacing either egg yolks or whole eggs. In the latter case, it is used in combination with egg white, which may or may not be in powder form. In other words, the whole egg is replaced by a whole egg substitute.

U.S. Pat. No. 4,752,484 describes a method of replacing whole eggs by whole egg substitutes.

WO-A-96/26644 describes how to improve the solidity of biscuits which are rolled during their production by adding a small proportion of egg white, which can be supplied in powder form if appropriate.

EP-A-0 421 509 describes rolled, filled foods, in which the filling is surrounded by a layer preventing the humidity of the filling from migrating into the outer part of the food, in which egg yolk and egg white are used both in powder form and separately, the former being used in the mixture and the latter being used in the protective layer.

The present invention is based upon the possibility of replacing eggs in pastry with the addition of powdered egg white or egg white substitute. This improvement enables the amount of egg in pastry—Viennese bakery products to be reduced.

That is why the present invention relates to a method for preparing a pastry—Viennese bakery product, whose base preparation uses whole eggs or mixtures of egg whites and egg yolks in liquid form, with the exception of Swiss rolls, characterised in that part of the quantity of whole eggs in liquid form of the base preparation required for obtaining a given quality in the pastry—Viennese bakery product is replaced with a composition comprising powdered egg white or one of the equivalent products well-known in the food and agriculture industry or in that such a composition is added to the said base preparation.

The pastry—Viennese bakery product can for example be constituted by sponge fingers, langues de chat, champagne sponges, Reims biscuits, madeleines, cakes, Sponge cakes, Sponge slices, Savoy biscuits, choux pastries, brioches, spiced breads, four fourths, pannetons, Kouglofs, blinis, quenelles and generally any other cakes with a yellow paste as well as pastries such as layered pastries.

The preparation of the above products requires the presence of whole eggs, i.e. egg yolk and egg white.

According to the invention, the composition comprising pulverised egg white powder is all the more efficient with increased fineness of the particle size.

According to the invention, “base preparation” is understood to mean the basic constituent parts of the recipe, for example eggs, sugar, water, flour, yeast and salt for a Sponge cake.

Egg white equivalents which are well-known in the food and agriculture industry are for example lactalbumins (products obtained from milk proteins: processed casein-rennet or precipitated serum albumin), wheat gluten which is split up in order to be enriched with albumin and carboxymethylcellulose. In general, egg white substitutes are in the form of clear powders, soluble in water, emulsifying well into a white and fluffy state by beating and able to coagulate with heat, like the egg whites which they can consequently replace from a mechanical and functional point of view.

It is therefore understood that it is possible to use a product which, strictly speaking, is not an egg white substitute, because it does not sufficiently expand, become frothy or coagulate, but the quantity of albumin, in particular lactalbumin, has a similar effectiveness in the method according to the invention.

These significant foaming properties are useful in order to characterise egg white substitutes which are themselves distinguished from whole egg substitutes which have much less significant foaming properties.

Egg white substitutes are for example marketed by Ingrédia, Armor Protéines, Epi Bretagne and Chamtor.

In the present invention and in the text below, the term pulverised egg white powder will be used to designate this or one of its above equivalents.

In the composition comprising pulverised egg white powder, the latter is advantageously pulverised to a granulometry below 63 μm for at least 60% of he particles, and preferably to a granulometry below 40 μm. Advantageously, the above granulometry values relate to 80%, particularly 90% and most articularly at least 95% of the particles.

The composition comprising pulverised egg white powder can be constituted by more than 80%, even totally, by powdered egg white. Such a composition is preferably used in order to improve the appearance of the final product.

Under preferred conditions for the implementation of the method, the composition comprising pulverised egg white powder comprises from 5 to 20% egg white in powder form by weight, preferably 7 to 15% and most particularly 10 to 12% by weight.

Under other preferred conditions for the implementation of the invention, the composition comprising pulverised egg white powder comprises from 15 to 50% proteins by weight, preferably 30 to 40% by weight when the proteins come from soya and 15 to 20% by weight when the proteins come from peas and rice.

These proteins can for example be provided by soya flour, pea flour, rice flour or a mixture of such products, in particular a mixture of pea flour and rice flour, these latter types of flour contain around 30 to 40% proteins and almost all of the remainder is constituted by starch-type glucides.

Under other preferred conditions for the implementation of the invention, the above composition also contains from 30 to 50% by weight of starch-type glucides, preferably from 35 to 45%.

Independently of the fact that these glucides can be provided for example by pea flour, rice flour or soya flour, they can also be provided for example by corn starch, wheat starch or potato flour.

Under yet more preferred conditions for the implementation of the invention, the above composition also contains lactoserum or a caseinate.

These latter products can for example represent from 15 to 25% of the weight of the dry matter.

Under yet more preferred conditions for the implementation of the invention, all the above ingredients making up the composition comprising pulverised egg white powder according to the invention are reduced to the same granulometry.

The present invention also relates to a food composition in powder form for the replacement of whole eggs, characterised in that it comprises the following by weight:

from 8 to 20% egg white powder,

from 20 to 40% proteins in the form of powder,

glucides

Under preferred conditions for the implementation of the invention, the remainder of the powdered composition according to the invention essentially comprises starch-type glucides in powder form.

Under other preferred conditions for the implementation of the invention, the powdered composition according to the invention also comprises from 15 to 25% lactoserum and caseinate in the form of powder.

Under yet more preferred conditions for the implementation of the invention, the above composition comprises from 30 to 50% by weight of starch-type glucides, preferably from 35 to 45% by weight.

Particularly preferred powdered compositions according to the invention include:

| | |
|---|---|
| Pea flour | 30 to 40% |
| Rice flour | 22 to 30% |
| Egg white | 10 to 14% |
| Lactoserum | 8 to 12% |
| Caseinate | 8 to 10% |
| Corn starch | 7 to 9% |

Under yet more preferred conditions for the implementation of the invention, at least 60% of the above powders are reduced to the same granulometry, advantageously below 63 μm, preferably below 40 μm, and in particular 80%, particularly 90% and most particularly at least 95% of the particles are affected by these granulometries.

The present invention also relates to the use of a powdered composition containing from 8 to 20% egg white powder advantageously matching the granulometries specified above, in order to replace part of the whole eggs (yolk and white) necessary for the preparation of a pastry—Viennese bakery product, and/or to improve the appearance thereof.

The methods and compositions according to the invention have remarkable properties.

In fact, they allow a substantial saving as about 20% of the whole eggs can be replaced whilst improving the quality of the final product. In fact, the substitute product consisting of egg white and added water is much cheaper than whole eggs.

In addition, the preparation and qualities of the finished product, namely rising during beating and rising in the oven, are very clearly superior to those obtained with egg alone. This improvement in the qualities can be measured by better development and greater homogeneity of the products.

The invention also provides an important advantage in relation to storage, since a powdered composition according to the invention is five times lighter than the corresponding quantity of eggs and there is no need to store it in cold storage. Its implementation is very simple as it is sufficient to add tap water.

Furthermore, the use of the compositions according to the invention also reduces the risks of bacterial contamination, for example salmonellosis, which is prone to being carried by whole eggs.

That is why the present invention has significant applications in pastry—Viennese bakery products, brioche production and bread-making requiring the use of whole eggs and generally in risen mixtures with whole eggs.

The following examples illustrate the present invention. For each of them, the granulometry of each ingredient was lower than 63 μm for 80% of the particles.

### EXAMPLE 1

By placing the different ingredients together in a grinder until the desired granulometry was obtained, a powdered composition to substitute whole eggs was prepared with the following composition:

| | |
|---|---|
| Pea flour in powder form | 35.5% |
| Rice flour in powder form | 25.5% |
| Egg white in powder form | 12% |
| Lactoserum in powder form | 10% |
| Caseinate in powder form | 9% |
| Corn starch in powder form | 8% |

### EXAMPLE 2

Similarly, a powdered composition to substitute whole eggs was prepared with the following composition:

| | |
|---|---|
| Soya flour in powder form | 60% |
| Egg white in powder form | 7% |
| Lactoserum in powder form | 10% |
| Caseinate in powder form | 7% |
| Corn starch in powder form | 16% |

### EXAMPLE 3

Similarly, a powdered composition to substitute whole eggs was prepared with the following composition:

| | |
|---|---|
| Soya flour in powder form | 50% |
| Rice flour in powder form | 10% |
| Egg white in powder form | 10% |
| Lactoserum in powder form | 10% |
| Caseinate in powder form | 8% |
| Corn starch in powder form | 12% |

Examples of Application

For each of the following, the granulometry of each solid ingredient was lower than 63 μm for 80% of the particles.

Example of Application No. 1—Brioches

Brioches were prepared as follows:

A conventional base preparation constituted by:

| | |
|---|---|
| Flour | 10 kg |
| Eggs | 4 kg |
| Butter | 2 kg |
| Sugar in powder form | 0.5 kg |
| Yeast | 0.3 kg |
| Salt | 0.2 kg |
| Emulsifiers (mono and diglycerides and lecithin) | 0.2 kg |
| Liquid milk | 1.2 kg |

is mixed with 200 g of the product of Example 1. The whole mixture is then put into tins and placed in the oven at 37° C. for about 45 mins.

Control brioches were also prepared as above, but without any product of Example 1 and conventionally using 5 kg of eggs instead of 4 kg and only 0.4 kg of liquid milk.

Control brioches were also prepared as above with some of the product of Example 1 but without egg white in powder form.

The results obtained are the following:

1) Control product: a normal good quality product is obtained.

2) product above: the product has risen so much that it is necessary to change the tins for larger ones in order to avoid it overflowing.

3) Product above, but without egg white: the product rises slightly less than the normal product.

Example of Application No. 2—Sponge Cakes

A conventional base preparation constituted by

| | |
|---|---|
| Eggs | 3.7 kg |
| Sugar | 6 kg |
| Water | 2 kg |
| Salt | 1 dessert spoon |

is mixed with 500 g of the product of Example 1. The whole mixture is whisked in order to make it rise. Then, 7 kg of sieved flour and 100 g of baking soda are added. The whole mixture is put into tins.

Control Sponge cakes were also prepared as above, but without any product of Example 1 and conventionally using 2.5 kg of additional eggs and no water.

Control Sponge cakes were also prepared as above with the product of Example 1 but without egg white in powder form.

The results obtained are the following:

1) Control products: the product is good and as it should be normally.

2) Products above: the final Sponge cakes rose slightly more.

3) Products above, but without egg white: the final Sponge cakes rise in a comparable way to the control products.

1. A method for preparing a food product, a recipe for which calls for a first quantity of whole eggs in liquid form to obtain a specific quantity of the food product, the method comprising the step of substituting for the first quantity of whole eggs in liquid form a combination of a second quantity of whole eggs in liquid form and pulverized egg white powder, the second quantity being less than the first quantity.

2. The method of claim 1, wherein a weight of the pulverized egg white powder is 1 to 4% of a weight of a difference between the first and second quantities.

3. The method of claim 1, wherein the pulverized egg white powder comprises particles that have a granularity lower than 63 μm for at least 60% of the particles.

4. The method of claim 1, wherein the combination further comprises water, and wherein a total weight of the water and the pulverized egg white powder is about the same as a weight of a difference between the first and second quantities.

5. The method of claim 1, wherein the combination further comprises flour in powder form and corn starch in powder form.

6. The method of claim 5, wherein the combination further comprises lactoserum in powder form and caseinate in powder form.

7. The method of claim 6, wherein the combination further comprises water, and wherein a total weight of the water, flour, corn starch, lactoserum, caseinate, and pulverized egg white powder is about the same as a weight of a difference between the first and second quantities.

8. A method for preparing a food product, a recipe for which calls for a particular amount of whole eggs in liquid form to obtain a specific quantity of the food product, the method comprising the step of:
substituting for the particular quantity of whole eggs in liquid form a combination of whole eggs in liquid form and a composition comprising by weight,

| | |
|---|---|
| Pea flour | 30 to 40% |
| Rice flour | 22 to 30% |
| Egg white | 10 to 14% |
| Lactoserum | 8 to 12% |
| Caseinate | 8 to 10% |
| Corn starch | 7 to 9% |

wherein the egg white is pulverized to a granulometry lower than 63 μm for at least 60% of the particles.

9. The method of claim 8, wherein the composition substitutes for about 20% of the particular quantity of whole eggs in liquid form.

10. A food composition in powder form for the replacement of whole eggs, comprising by weight:

| | |
|---|---|
| Pea flour | 30 to 40% |
| Rice flour | 22 to 30% |
| Egg white | 10 to 14% |
| Lactoserum | 8 to 12% |
| Caseinate | 8 to 10% |
| Corn starch | 7 to 9% |

wherein the egg white is pulverized to a granulometry lower than 63 μm for at least 60% of the particles.
